(19) United States
(12) Patent Application Publication
(10) Pub. No.: US 2014/0304147 A1
(43) Pub. Date: Oct. 9, 2014

(54) SYSTEM TO ALLOCATE PAYROLL FUNDS TO PREPAID INSTRUMENTS

(71) Applicant: FIRST DATA CORPORATION, Greenwood Village, CO (US)

(72) Inventor: Kristina Wolff, Omaha, NE (US)

(73) Assignee: First Data Corporation, Greenwood Village, CO (US)

(21) Appl. No.: 13/856,966

(22) Filed: Apr. 4, 2013

(51) Int. Cl. G06Q 20/10; G06Q 20/34

(52) U.S. Cl. CPC G06Q 20/10; G06Q 20/342
USPC 705/39

(57) ABSTRACT

A payroll management system receives employee enrollment in a program for having proceeds from a paycheck allocated to one or more gift cards, with net proceeds after the allocation deposited into a demand deposit (checking) account or any other deposit mechanism such as an open loop credit instrument. The gift cards are used at specified retailers, and automatically provide discounts on goods/services purchased using the cards.

### BACKGROUND OF THE INVENTION

Employers often provide options for employee paychecks to be directly deposited into various types of financial accounts, rather than being issued to employees as paper checks. While programs for permitting employees to elect various paycheck options provide benefits to employees, such as convenience and flexibility, there is need for those programs to provide unique benefits for an employer to increase the likelihood of employee retention, thereby decreasing churn and the cost of hiring, training, and attrition.

### BRIEF SUMMARY OF THE INVENTION

There is provided, in accordance with embodiments of the present invention, a network/system and method for allocating pay from a paycheck to accounts, such as a prepaid account for use in conducting transactions at a specified retailer.

In one embodiment, a system and method provides for electronically enrolling an employee in a payroll allocation program at an enrollment system, wherein the employee may elect to have at least a portion of a paycheck transferred from a payroll system to a prepaid card account, wherein the prepaid card account is used to make purchases at one or more specified retailers. The system and method further provides for electronically providing a discount for goods or services purchased with the use of the prepaid card account at a point-of-sale device of the specified retailers, in order to provide an incentive to the employee to elect to transfer funds to the prepaid card account.

A more complete understanding of the present invention may be derived by referring to the detailed description of the invention and to the claims, when considered in connection with the Figures.

### BRIEF DESCRIPTION OF THE DRAWINGS

FIG. 1 is a block diagram illustrating a payroll and payment system in accordance with an embodiment of the invention.

FIG. 2 is a flow diagram illustrating a process whereby an employee receives and uses a gift card having allocated paycheck proceeds.

FIG. 3 illustrates a website page used by an employee for enrolling in a program for allocating paycheck proceeds to a gift card.

FIG. 4 is a flow diagram illustrating a process whereby an employee uses a gift card for a purchase, with a determination of whether or not the gift cardholder is entitled to a discount.

FIG. 5 is a block diagram illustrating an exemplary computer system upon which embodiments of the present invention may be implemented.

### DETAILED DESCRIPTION OF THE INVENTION

Generally speaking, embodiments of the invention provide greater flexibility to employees in receiving paycheck proceeds, while at the same time provide benefits to employers and/or employees when proceeds from a paycheck are allocated to a prepaid card account.

In one embodiment, an employee is provided an enrollment option for having an amount from a paycheck posted or deposited to a prepaid card account. The prepaid account is used by the cardholder (employee) to make purchases at a specified retailer. When the card is used to conduct a transaction at the retailer, a discount is provided to the cardholder for purchases made.

Prepaid cards for use at a specified retailer are often referred to as “gift cards” or “closed system” cards, since they represent a stored value card for use only at the retailer that has issued the card. It should be appreciated that, even though referred to herein as “gift cards,” such cards can be used by any person in possession of the card, and hence they may not only be used as a gift card (by a person receiving the card as a gift from some other person purchasing the card), but also be used as a prepaid transaction card by the person that has purchased (and loaded funds onto) the card.

Such cards often provide significant financial value to the issuing retailer, since the cardholder will use the card only for purchases at the retailer (providing assured business to the retailer), and since the retailer retains the value of the “float” (the use of money on the card) until the amounts loaded onto the card are redeemed or used for purchases. In one aspect of the invention, the retailer issuing the card uses at least part of that financial value to provide incentives to employees (and their employer) to allocate paycheck proceeds to prepaid cards.

For example, in a described embodiment, the issuing retailer provides discounts to employees that are using a prepaid card to which paycheck proceeds have been allocated. Thus, if the employee has elected to allocate or load, say, $100 to a prepaid card, the retailer may provide a 10% discount for goods or services purchased at the retailer when using the card. The discount applies to any goods or services that are purchased at the retailer, thus assuring the cardholder (employee) that by allocating $100 to the prepaid card, the employee is in effect receiving over $110 in value to make purchases. Such value is particularly useful to a cardholder when the retailer provides essential goods or services, such as food and gasoline.

As another example, in the described embodiment, the employer receives compensation in the form of a commission for each prepaid card to which funds are allocated by employees. Commissions are often provided to retail outlets that sell gift cards and other prepaid cards, and the compensation to the employer is in effect the commission the employer (as the selling entity) receives for arranging the “purchase” of a prepaid card by an employee. Such a commission, when aggregated for all employees electing to purchase prepaid cards with paycheck proceeds, can be used to reduce the costs of the employer in administering its payroll system.

While described embodiments relate to the use of prepaid “closed system” cards, other embodiments may be implemented with different forms of card systems. For example, “semi-closed system” cards may be used. Semi-closed prepaid cards are used at groups of retailers (such as multiple merchants located in a shopping mall or other geographic area), with the entity administering the card agreeing that each retailer in the group will provide discounts to the cardholder. Also, “open system” prepaid cards, that are endorsed by electronic payment network (such as VISA, MASTERCARD or AMERICAN EXPRESS) may also be used, when there is an incentive to the employee to allocate paycheck proceeds (e.g., purchases made with a card will result in a discount to the cardholder/employee).

It should be noted that, as used herein, the term “card” is meant to include broadly any type of presentation instrument having an associated account in which funds are stored or represented, and which may be used by a customer to conduct a transaction. Thus, by way of example, a card includes not only traditional, physical cards (having a credit card or debit card like structure), but also virtual cards, such as an electronic device (RFID device) having a stored account number that is accessed in order to conduct a transaction, or even a standalone card/account number (with no associated physical card or device) that is provided by the account holder to a merchant in order to conduct a transaction. A card transaction broadly includes not only transactions conducted at a merchant POS (point-of-sale) system in order to purchase goods or services, but also other financial transactions in which an incentive (such as a discount or a commission) may be provided to a cardholder (employee) using the card or provided to an employer facilitating the purchase of such cards through payroll deductions.

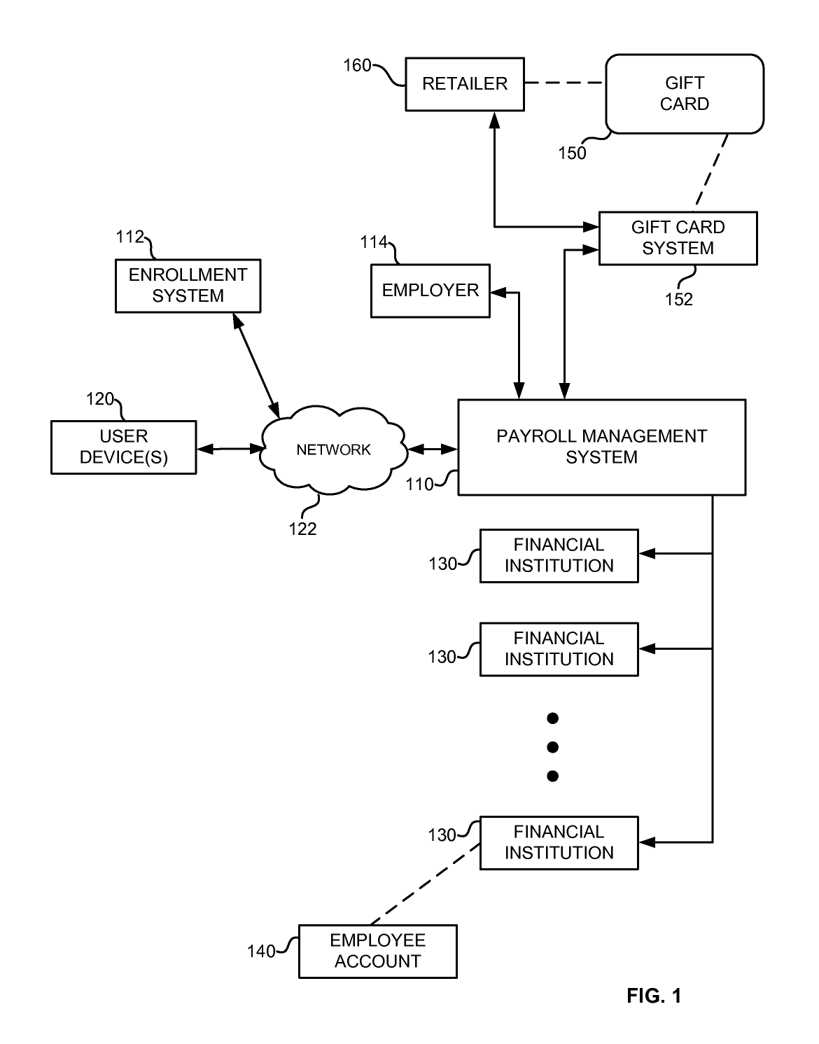

As mentioned, there are various embodiments and configurations for implementing the present invention. One such implementation is shown in FIG. 1, illustrating a payroll and payment system 100 that includes a payroll management system 110 and a payroll enrollment system 112.

In general, the payroll management system 110 manages the payroll of an employer 114, such as by processing payroll data from the employer, and issuing paper paychecks or electronic payments to an employee after withholding taxes and other payroll deductions. The enrollment system 112 permits employees to enroll in the payroll system of their employer, and thereafter to make changes to payroll features or options, e.g., as employee circumstances change and different payroll options are offered. Employees may enroll and make changes at the enrollment system 112 with the use of user devices 120. The payroll management system 110, enrollment system 112 and user devices 120 may be interconnected by a network 122, which in one embodiment may be the Internet. As an example, the enrollment system 112 may include a server that hosts a website at which the employee may view payroll options and enter data at a user device 120 having associated input/output devices (keyboard, mouse, display screen, etc.). Employee data and elected options captured at the website (via user device 120) may be provided from the enrollment system 112 over network 122 to the payroll management system 110.

In some embodiments, the payroll management system 110 and/or the enrollment system 112 may be operated by a third party, such as a third party payroll administration service. In other embodiments, the payroll management system 110 and/or the enrollment system 112 may be operated by the employer 120. In either such embodiments, the third party or the employer makes arrangements for payroll amounts to be deposited electronically for the benefit of the employee into one or more accounts that are held by or on behalf of the employee.

The payroll management system 110 is connected to various financial institutions 130 that may maintain accounts for employees. The financial institutions may include banks, credit unions, brokerage firms or other types of financial institutions where payroll deposits may be made, such as deposits to an illustrated account 140, which may (for example) be a demand deposit account (checking account) for one of the employees receiving direct deposits.

After an employee is enrolled at the enrollment system 112, the employer 120 periodically provides payroll information (e.g., gross wages, hours worked, deductions, etc.) to the payroll payment system 112, which in turn calculates net payroll amounts (e.g., after withholding taxes and other items from gross pay), thus enabling the payroll management system 112 to issue payroll checks to employees, such as by electronic deposits to accounts of employees at the various financial institutions 130.

In accordance with one aspect of the invention, the entity that operates the payroll management system 110 may offer an option, pursuant to which a gift card 150 managed by a gift card system 152 is made available to employees. The gift card system manages a prepaid account (separate from any employee account maintained at the financial institutions 130) into which an amount is allocated from paycheck proceeds, for example, allocated prior to the net proceeds being deposited into the employee account 140. The gift card 150 may be used to make purchases at a retailer 160 issuing the card and, as will be described in greater detail later, discounts are provided to the employee when using the gift card at the retailer 160.

Thus, if an employee elects to have an amount from a paycheck allocated to the gift card 150, the payroll management system 110 communicates the allocated amount to the gift card system 152, and an individual account for the employee (corresponding to the gift card 150) is set up (if not already established) and maintained at the gift card system 152, and funded with the allocated amount. The allocated amounts may be ultimately provided to the retailer (to be held for the benefit of the cardholder), but the value (to the employee) remains in the account associated with the gift card until it is used or redeemed by the employee (gift cardholder) for purchases at the retailer. While the gift card system 152 maintains the individual gift card accounts for each cardholder, it should appreciated that such accounts merely reflect an accounting credit or value (given to the cardholder) for purchases to be made at the retailer. Thus, while the employee/cardholder is provided a credit to be used, the actual money is held by the retailer and the retailer obtains the benefit of the money until it is used by the cardholder. Thus, in effect, the retailer may use and invest that money as it sees fit, such as by depositing the money into an account of the retailer maintained at one of the financial institutions 130, while at the same time making the money available at gift card system 152 for the employee to use in the future for purchases at the retailer. When the card is used at the retailer (e.g., card data is swiped or entered at a retailer point-of-sale (POS) terminal), the amount of the purchase is communicated to the gift card system 152 and a corresponding debit is made against the gift card account.

As noted earlier, while the term “gift card” is used in referring to card 150 (and system 152), it should be appreciated that the card 150 may not be given (and may never be intended to be given) by the employee as a gift from the employee to another person. Rather, the card 150 may be used only by the employee, unless or until the employee choses to do otherwise. Thus, in effect, the gift card 150 is not necessarily tied to any specific person when enable for use, but rather may be used by any person having authorized possession of the card.

In some embodiments, the gift card system 152 may be operated by the retailer issuing the card 150. However, in other embodiments, the gift card system 152 may be operated by a third party that processes and charges a processing fee to the merchant for each transaction using the gift card. Further, while the gift card 150 is referred to herein as being “issued” by the retailer 160 (since in the described embodiment the card 150 is used only for purchases at the retailer 160), the card may in fact be produced and distributed by a third party on behalf of the retailer, such as a third party entity operating the gift card system 152.

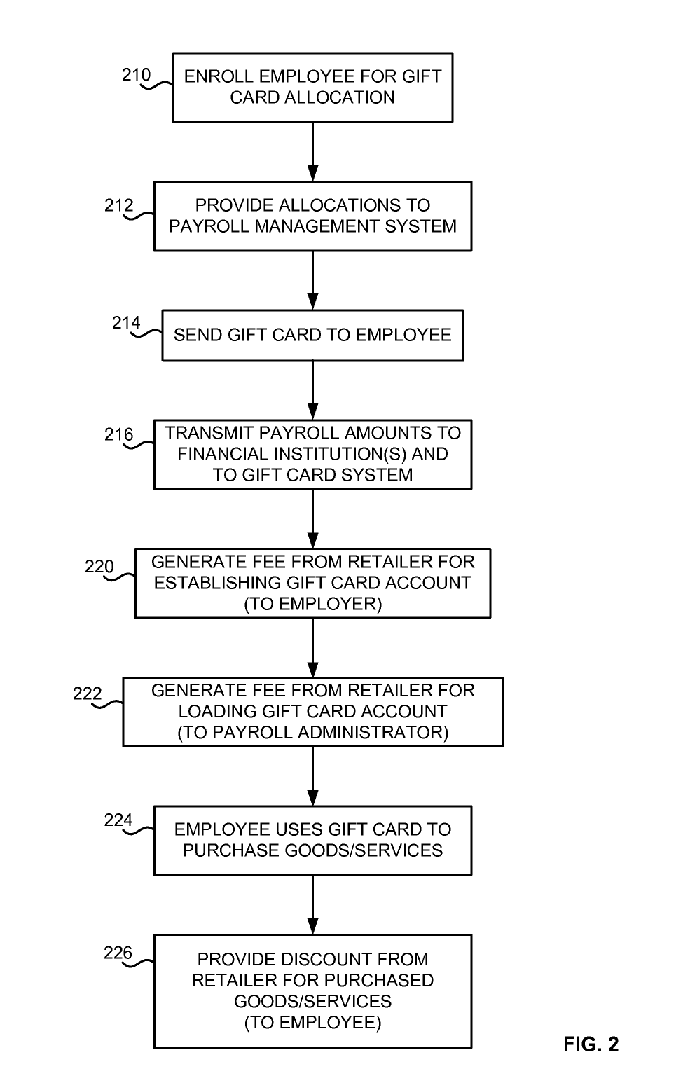

FIG. 2 is a flow diagram illustrating one embodiment of a process implemented within system 100 of FIG. 1.

A step 210, an employee enrolls (at enrollment system 112) in a program for receiving a gift card and for having a portion of the employee's pay allocated to a gift card account associated with the card. At step 212, the enrollment system 112 provides the entered enrollment information (including information identifying the employee and the amount of the paycheck to be allocated to the gift card) to the payroll management system 110. As should be appreciated, enrollment may reflect a change in previous elections (e.g., increasing or decreasing the amount to be allocated to a pre-existing card) or may reflect a new enrollment. If a new enrollment, a gift card account is set up for the employee. If a change to a previous amount, the payroll system adjusts the amount that will be allocated from pay for the next pay period. At step 214, if the enrollment is for a new gift card, the payroll management system communicates such information to the gift card system 152, a gift card (and associated gift card account) is established, and the new gift card is sent to the employee, for use when the allocated amounts are put into the newly established gift card and associated account.

At step 216, when the payroll for the next pay period is processed, payroll amounts are transmitted to the financial institution 130 where an employee account had been designated for receiving net paycheck proceeds, and to the gift card system 152. In the described embodiment, net proceeds are deposited into a checking account (such as the account 140 illustrated in FIG. 1), with the payroll management system determining the net proceeds after withholding taxes and other deductions (including a deduction attributed to an amount allocated to the gift card 150). In other embodiments, net proceeds may be deposited into other types of accounts, including open loop card accounts.

In accordance with one embodiment, when an allocation to a gift card occurs, the retailer generates and sends a commission or fee to the employer establishing the gift card (step 220). As an example, the retailer issuing the gift card may agree to provide a gift card set up fee (akin to the fee that a merchant selling gift cards may receive) at the time that the gift card is set up and each time funds are loaded on to the card (i.e., credited to the account maintained at gift card system 152 that is associated with the card). Among other things, such fees (when aggregated by the employer for all employees electing amounts to be allocated to gift cards) may be used by the employer to offset the costs associated with managing its payroll system, such as the costs paid to a third party payroll administrator for operating and maintaining the payroll management system 110. At step 222, the retailer may also generate and provide, to the payroll administrator (or the employer) that operates system 110, a transaction fee based on the amount of the money loaded onto gift cards. This again is akin to a merchant that loads pre-existing cards, with the retailer providing a loading transaction fee to the loading merchant each time money is loaded onto a gift card based on money provided to the loading merchant from an existing cardholder.

At step 224, the employee then uses the gift card 150 to make purchases at the retailer 160. For each such purchase transaction, the employee automatically receives a discount on the amount of purchases, step 226. As mentioned earlier, this in effect gives the employee value in excess of the amount allocated to the card, by permitting the employee to purchase discounted goods/services each time the card is used. In one embodiment, the discount is calculated by the gift card system 152 each time a transaction is made against the card. While, in the described embodiment, the discount is applied to all goods or services purchased at the retailer, in other embodiments the discounts may be based on the nature of the products or series purchased or the amount of the purchase (as an example only, discounts may be applied to staples or necessities, such a food, clothing, healthcare, and car fuel, and not applied to alcohol or cigarettes). Such discounts could also be based on parameters established by the employer, who may seek to have employees receive additional value for purchased categories of goods or service that are seen as healthy or consistent with the employer's values or the nature of the employee's job, and to not apply discounts to other categories of goods or services.

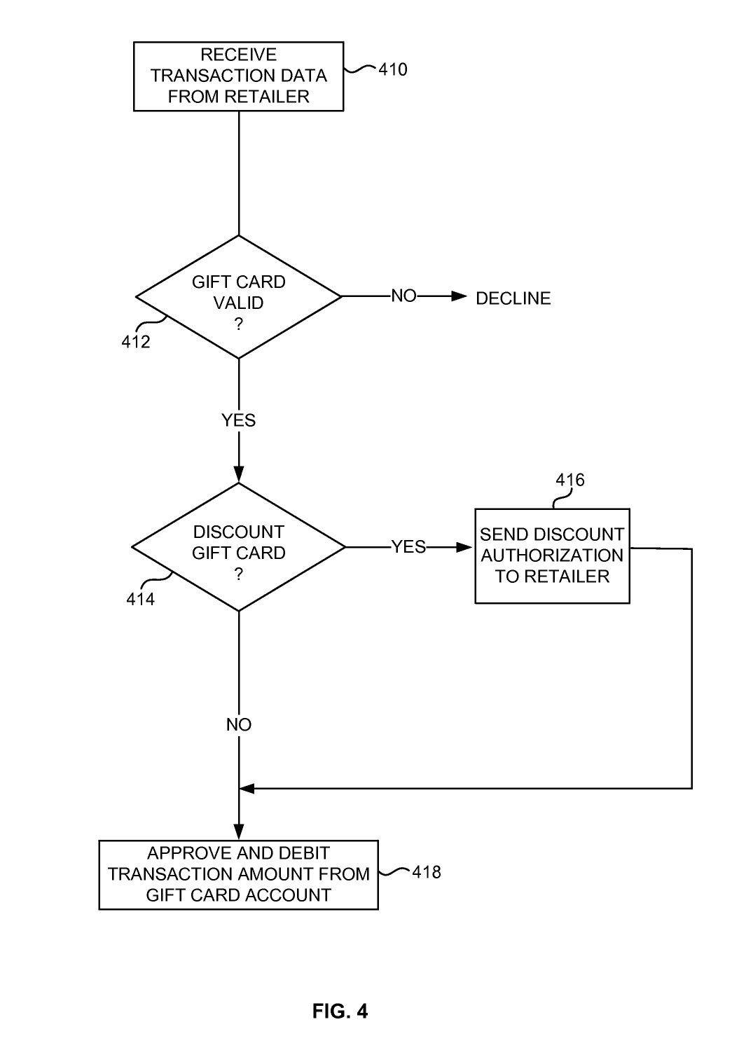

A more detailed process for processing a gift card transaction and providing a discount will be described later in conjunction with FIG. 4.

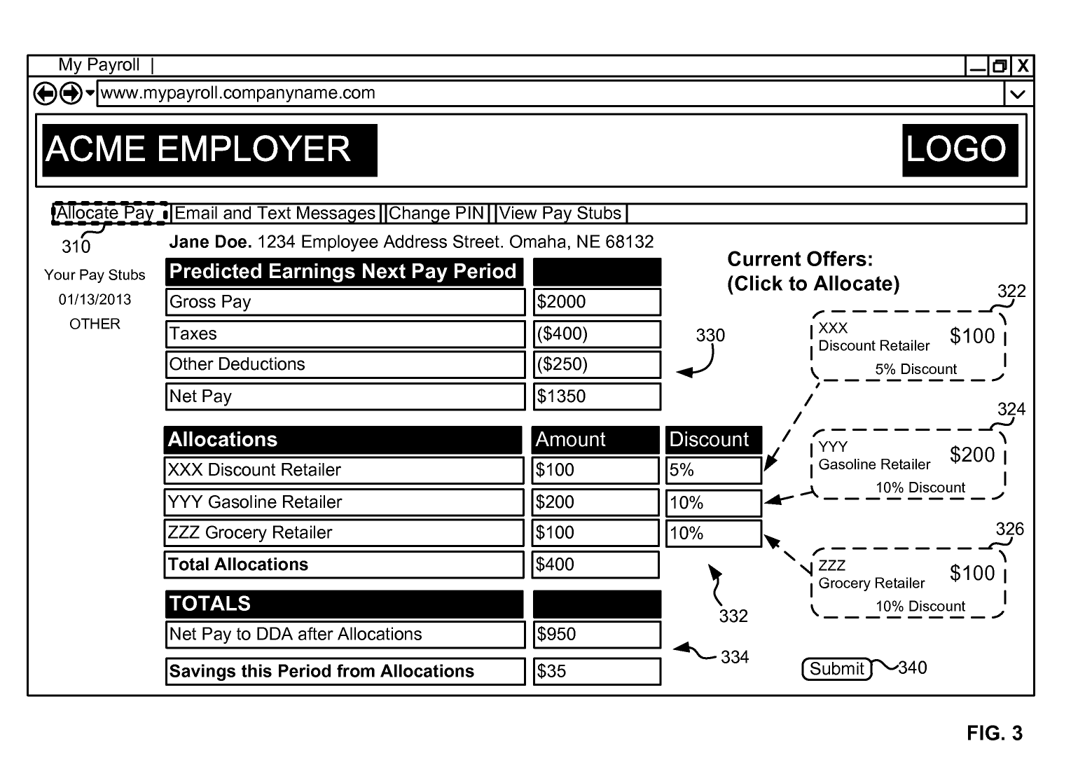

FIG. 3 illustrates a screen at user device 120 displaying a website page used by an employee to enroll in a program for allocating paycheck proceeds to one or more gift cards. The screen might be displayed in response to an employee going to the website to get payroll information or enroll in a payroll options.

As seen in FIG. 3, an “Allocate Pay” button 310 has been clicked or activated to display the website site page showing predicted earnings and pay. As part of the screen, current gift card offers available to the employee are displayed, such as illustrated gift card offers 322, 324 and 326. FIG. 3 illustrates an employee's preliminary election of all three gift card offers, with allocated amounts used in determining predicted earnings and net pay for the employee. Offer 322 represents a $100 gift card for a discount retail chain (with an automatic 5% discount on all purchases made with the card at any store in the discount retail chain), offer 324 represents a $200 gift card for a gasoline retailer (with an automatic 10% discount on all purchases made with the card at the gasoline retailer stations), and offer 326 represents a $100 gift card for a grocery retail chain (with an automatic 10% discount on all purchases made with the card at any store in grocery chain).

For the employee reviewing the website page, the screen includes a data display portion 330 reflecting net pay after taxes and other normal deductions, a data display portion 332 reflecting the results of allocations by clicking on one or more of the offers 322, 324 and 326, and a data display portion 334 reflecting the net pay after allocations. As seen, net pay after allocation are deposited into a demand deposit account (checking account) of the employee. Also seen at data display portion 334 are savings to the employee from discounts associated with the gift cards. The employee may accept the preliminary elections (resulting in the displayed predicted net pay), by clicking or selecting a submit button 340.

FIG. 4 illustrates a process implemented within gift card system 152 for providing a discount to an employee as a result using a gift card issued in response to the gift card offers displayed in FIG. 3. It is contemplated that the steps in the process of FIG. 4 may be performed primarily at gift card system 152, when the employee is using an employer-offered gift card at a retailer to purchase goods or services (step 224 in FIG. 2).

At step 410, transaction data captured by the retailer 114 (e.g., at a retailer POS terminal in response to a transaction being conducted using the gift card 150), is received at the gift card system 152. The transaction data would include the amount of the transaction and the gift card number (or account number) associated with the card being used. The gift card system determines whether the gift card is valid at step 412. The determination can be made based on various factors, such as whether the card number (or account number) associated with the gift card is valid, and whether it has a current balance. If the card is not valid, a decline message is returned by the gift card system to the retailer. If the gift card is valid, the gift card determines (step 414) whether there is a discount associated with the gift card (e.g., one of the discounts illustrated in FIG. 3).

Step 414 could be implemented in various ways. In one embodiment, each gift card to which paycheck proceeds have been allocated has an associated a gift card number. The gift card number (or some portion of the gift card number) identifies whether a discount is applicable. For example, gift card system 152 may include (e.g., stored in an associated database or memory), in association with each of the gift card accounts maintained at gift card system 152, an indication of the amount of any discount automatically applied when using the card. If there is a discount, then at step 416 the gift card system returns a discount authorization message to the retailer, indicating the amount of the discount, which is then applied at a retailer POS terminal (e.g., displaying at the POS terminal the applicable discount and the final purchase price after applying the discount).

At step 418, the gift card system 152 then approves and debits the transaction amount (after any applicable discount) from the account associated with the card and maintained at the gift card system 152. Since the retailer may have gift cards presented both by employees having automatic discounts and others customers having gift cards without automatic discounts, in some instances at step 414 the gift card processed at gift card system is valid but not one having a discount, in which case the full amount of the transaction is approved and debited from the associated gift card account at step 418.

It should be appreciated that, in some instances, the balance on a gift card may be close to (or even slightly below) the amount of the transaction, and at step 412 the gift card system may in fact check for any discount before declining a transaction based on the balance. Thus, if a card having an applicable discount is used and the amount of the transaction is close to or slightly below the card balance, the gift card system may be programmed to not decline the transaction at step 412 without first applying the discount. For example, based on the largest discounts available (say, 10%), the gift card system 152 may be programmed not to reject (at least initially) any transaction where the amount of the purchase is 10% or less over the current gift card balance. Although not illustrated in FIG. 4, even if a transaction is ultimately declined at step 412 (for not having a sufficient balance on the card), the decline message to the retailer may indicate the amount of the deficiency and permit the employee to apply cash (in addition to the card balance) at the retailer in order to complete the transaction.

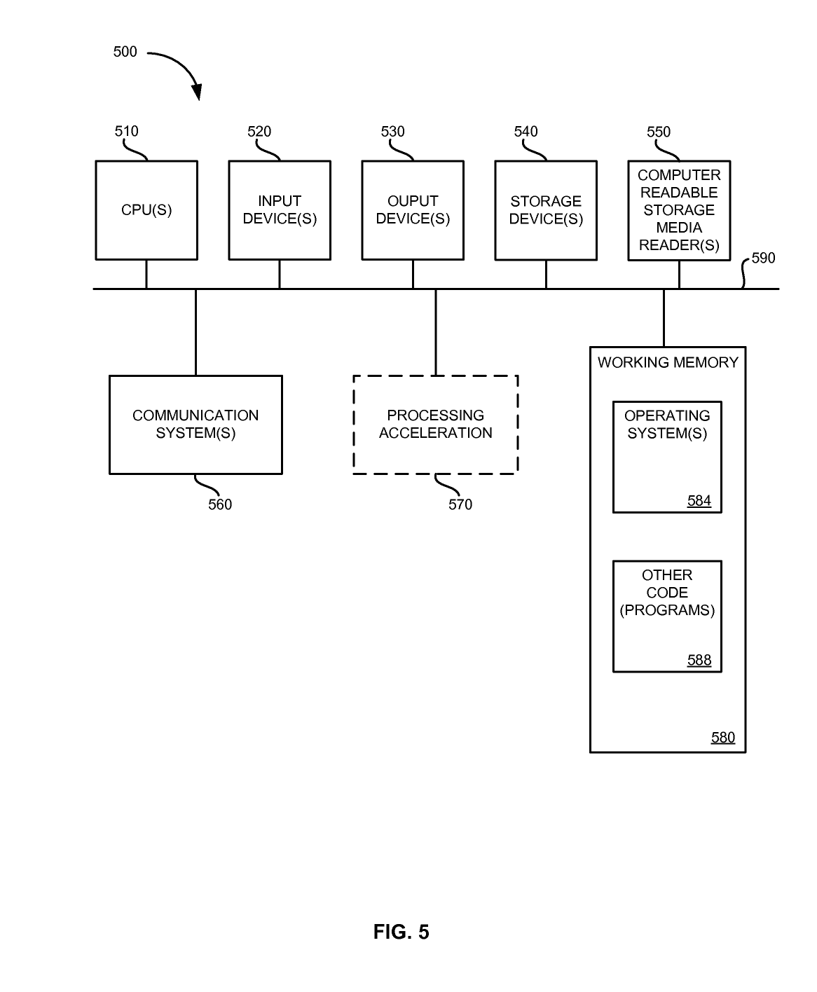

FIG. 5 is a block diagram illustrating an exemplary computer system upon which embodiments of the present invention may be implemented. This example illustrates a computer system 500 such as may be used, in whole, in part, or with various modifications, to provide the functions of the payroll management system 110, the enrollment system 112, the user devices 120, and the gift card system 152, as well as other components and functions of the invention described herein.

The computer system 500 is shown comprising hardware elements that may be electrically coupled via a bus 590. The hardware elements may include one or more central processing units 510, one or more input devices 520 (e.g., a mouse, a keyboard, etc.), and one or more output devices 530 (e.g., a display device, a printer, etc.). The computer system 500 may also include one or more storage devices 540, representing remote, local, fixed, and/or removable storage devices and storage media for temporarily and/or more permanently containing computer-readable information, and one or more storage media reader(s) 550 for accessing the storage device(s) 550. By way of example, storage device(s) 540 may be disk drives, optical storage devices, solid-state storage device such as a random access memory (“RAM”) and/or a read-only memory (“ROM”), which can be programmable, flash-updateable or the like.

The computer system 500 may additionally include a communications system 560 (e.g., a modem, a network card—wireless or wired, an infra-red communication device, a Bluetooth™ device, a near field communications (NFC) device, a cellular communication device, etc.) The communications system 560 may permit data to be exchanged with a network, system, computer, mobile device and/or other component as described earlier. The system 500 also includes working memory 580, which may include RAM and ROM devices as described above. In some embodiments, the computer system 500 may also include a processing acceleration unit 570, which can include a digital signal processor, a special-purpose processor and/or the like.

The computer system 500 may also comprise software elements, shown as being located within working memory 580, including an operating system 584 and/or other code 588.

Software code 588 may be used for implementing functions of various elements of the architecture as described herein. For example, software stored on and/or executed by a computer system, such as system 500, can be used in implementing the processes seen in FIGS. 2 and 4.

It should be appreciated that alternative embodiments of a computer system 500 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the payroll management system 110, the enrollment system 112, and the gift card system 152 may be implemented by a single system having one or more storage device and processing elements. As another example, the same systems 110, 112 and 152 may each be implemented by plural systems, with their respective functions distributed across different systems either in one location or across a plurality of linked locations.

Moreover, while the various flows and processes described herein (e.g., those illustrated in FIGS. 2 and 4) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Further, the term “exemplary” used herein does not mean that the described example is preferred or better than other examples.

What is claimed is:

1. A method for allocating a paycheck amount paid by an employer to an employee, comprising:
electronically enrolling, by one or more processors, an employee in a payroll allocation program at an enrollment system, wherein the employee may elect to have at least a portion of a paycheck transferred from a payroll system to a prepaid card account, wherein the prepaid card account is used to make purchases at a specified retailer; and
electronically providing, by one or more of the processors, a discount for goods or services purchased with the use of the prepaid card account at the specified retailer, in order to provide an incentive to the employee to elect to transfer funds to the prepaid card account.

2. The method of claim 1, further comprising:
providing a commission to the employer based on the enrollment of the employee in the payroll allocation program.

3. The method of claim 1, wherein the payroll system is operated by a third party that is not the employer, the method further comprising:
providing a loading fee to the third party operating the payroll system in response to transferring a portion of a paycheck into the prepaid card account.

4. The method of claim 1, wherein the prepaid card account is managed at a card management system, wherein the card management system maintains data reflecting the discount on goods or services purchased in a transaction using the one or more prepaid card accounts at the specified retailer, and wherein the card management system debits an amount of the transaction from the prepaid card account after applying the discount.

7. The method of claim 4, wherein the card management system:
determines a balance at the prepaid card account;
determines whether the balance at the prepaid card account is sufficient to conduct the transaction; and
determines, prior to determining whether the balance at the prepaid card account is sufficient to conduct the transaction, the amount of the transaction after applying the discount to the transaction.

8. The method of claim 1, wherein a net paycheck amount is deposited into a demand deposit account of the employee, after transferring a portion of a paycheck into the prepaid card account.

7. A method of allocating a paycheck paid by an employer to an employee, comprising:
enrolling an employee in an payroll program for allocating a paycheck amount between at least a first paycheck amount to be deposited to a financial account and a second paycheck amount to be loaded into one or more prepaid card accounts, each prepaid card account associated at least one retailer, each prepaid card account used for a transaction at the associated retailer for purchase of goods or services, and each prepaid card account maintained at a card management system;
receiving, at a payroll system from the employer, paycheck data representing the paycheck amount;
transmitting, from the payroll system to a financial institution, first allocation data representing the first paycheck amount that has been allocated to the financial account;
transmitting, from the payroll system to the card management system, second allocation data representing the second paycheck amount that has been allocated to the one or more prepaid card accounts;
issuing a prepaid card to the employee for transactions conducted against the one or more prepaid card accounts at the associated retailer;
loading, at the card management card system and into the one or more prepaid card accounts, the second paycheck amount; and
in response to using the issued prepaid card at the associated retailer, providing a predetermined discount on goods or services purchased at the associated retailer.

8. The method of claim 7, further comprising:
providing a commission to the employer based on the enrollment of the employee in the allocation program.

9. The method of claim 7, wherein the payroll system is operated by a third party that is not the employer, the method further comprising:
providing a loading fee to the third party operating the payroll system in response to loading the second paycheck amount into the one or more prepaid a card accounts.

10. The method of claim 7, wherein the card management system maintains data reflecting the predetermined discount, and wherein the card management system debits an amount of the transaction at the associated retailer for purchase of goods or services, after applying the predetermined discount.

11. The method of claim 10, wherein the card management system:
determines the balance at the one or more prepaid accounts;
determines whether the balance at the one or more prepaid accounts is sufficient to conduct the transaction; and
determines, prior to determining whether the balance at the one or more prepaid accounts is sufficient to conduct the transaction, the amount of the transaction after applying the discount to the transaction.

12. The method of claim 7, wherein the financial account is a demand deposit account.

13. A system for allocating a paycheck amount paid by an employer to an employee, comprising:
a processor; and
a memory, the memory comprising a data storage area and also storing instructions that are executable by the processor and configure the system to:
enroll an employee in an payroll program for allocating a paycheck amount between at least a first paycheck amount to be deposited to a financial account and a second paycheck amount to be loaded into one or more prepaid card accounts, each prepaid card account associated with at least one retailer, each prepaid card account used for a transaction at the associated retailer for purchase of goods or services, and each prepaid card account maintained at a card management system;
receive, at a payroll system from the employer, paycheck data representing the paycheck amount;
transmit, from the payroll system to a financial institution, first allocation data representing the first paycheck amount that has been allocated to the financial account;
transmit, from the payroll system to the card management system, second allocation data representing the second paycheck amount that has been allocated to the one or more prepaid card accounts;
issue a prepaid card to the employee for transactions conducted against the one or more prepaid card accounts at the associated retailer;
load at the card management card system and into the one or more prepaid card accounts, the second paycheck amount; and
in response to using the issued prepaid card at the associated retailer, provide a predetermined discount on goods or services purchased at the associated retailer.

14. The system of claim 13, wherein the memory stores further instructions that are executable by the processor and configure the system to:
provide a commission to the employer based on the enrollment of the employee in the allocation program.

15. The system of claim 13, wherein the payroll system is operated by a third party that is not the employer, and wherein the memory stores further instructions that are executable by the processor and configure the system to:
provide a loading fee to the third party operating the payroll system in response to loading the second paycheck amount into the one or more prepaid card accounts.

16. The system of claim 13, wherein the card management system maintains data reflecting the predetermined discount, and wherein the memory stores further instructions that are executable by the processor and configure the system to debit an amount of the transaction at the associated retailer for purchase of goods or services, after applying the predetermined discount.

17. The system of claim 16, wherein the memory stores further instructions that are executable by the processor and configure the system to:
determine the balance at the one or more prepaid accounts;
determine whether the balance at the one or more prepaid accounts is sufficient to conduct the transaction; and
determine, prior to determining whether the balance at the one or more prepaid account is sufficient to conduct the transaction, the amount of the transaction after applying the discount to the transaction.

18. The system of claim 13, wherein the financial account is a demand deposit account.

19. The system of claim 13, wherein the prepaid card is a gift card.

20. The system of claim 13, wherein the prepaid card is selected form a group comprising a prepaid gift card, a prepaid closed system card, a prepaid semi-closed system card, and a prepaid open system card that automatically provides discounts to purchases made by the employee when using the card.
